(19) United States
(12) Patent Application Publication
(10) Pub. No.: US 2026/0352634 A1
(43) Pub. Date: Nov. 5, 2026

(54) INLINE MAIL PROTECTION

(71) Applicant: Abnormal AI, Inc., Las Vegas, NV (US)

(72) Inventors: Sanjay Jeyakumar, El Cerrito, CA (US); Abhijit Bagri, Atlanta, GA (US); Tanooj Vipul Parekh, Mountain View, CA (US); Yicheng Wang, San Francisco, CA (US); Franklin X. Wang, Bellevue, WA (US); Ryan Wilson Orr, Stratford (CA); Alexander Joseph Vetras, Portland, OR (US); Michael Douglas Kralka, London (GB)

(21) Appl. No.: 19/195,341

(22) Filed: Apr. 30, 2025

(51) Int. Cl. H04L 9/40

(52) U.S. Cl. CPC H04L 63/0245; H04L 63/0263

(57) ABSTRACT

An implementation of an inline transport rule to forward messages received at an email service provider for a user to a third-party security analysis service different from the email service provider is caused to occur. An implementation of one or more email filtering rules for an email mailbox of the user is caused to occur. The messages are analyzed for security risks and corresponding headers of the messages are modified to include corresponding security analysis results. The analyzed messages with modified headers are routed back to the email service provider, wherein the email service provider uses the one or more email filtering rules to filter the messages based on the corresponding headers of the messages to implement one or more responsive security actions.

### BACKGROUND OF THE INVENTION

Email security has traditionally relied on pre-delivery or post-delivery inspection methods to identify and manage security risks such as unwanted or malicious messages. Pre-delivery solutions often act as gatekeepers, inspecting and potentially quarantining emails before they reach a user's mailbox. While effective in filtering certain threats, these systems can introduce reliability issues and dependencies that impact mail availability or fail to leverage the protections and context provided by the underlying email platform. Post-delivery solutions, by contrast, analyze messages after they have arrived in a user's mailbox. These approaches generally offer greater flexibility. Compared to pre-delivery solutions, they can also minimize the number of required changes to user behavior but typically require external interfaces to support third-party security inspection solutions capable of identifying more advanced threats. As a result, organizations face trade-offs when deciding between default, pre-delivery, and post-delivery inspection methods, often balancing factors such as reliability, compatibility, and advanced security risk detection. Therefore, there is a need for a high-performing email security solution capable of detecting advanced security risks that also improves on the reliability of pre-delivery inspection methods while supporting the underlying email platform with minimal impact to expected user behavior.

### BRIEF DESCRIPTION OF THE DRAWINGS

Various embodiments of the invention are disclosed in the following detailed description and the accompanying drawings.

FIG. 1 is a block diagram illustrating an embodiment of a system for providing inline mail protection.

FIG. 2 is a block diagram illustrating an embodiment of a system for providing inline mail protection.

FIG. 3 is a block diagram illustrating an embodiment of a security analysis service for providing inline security analysis for email messages.

FIG. 4 is a flow chart illustrating an embodiment of a process for protecting emails against security threats using a third-party security analysis service.

FIG. 5 is a flow chart illustrating an embodiment of a process for configuring inline security risk analysis for emails using a third-party security analysis service.

FIG. 6 is a flow chart illustrating an embodiment of a process for performing inline security risk analysis for emails using a third-party security analysis service.

FIG. 7 is a flow chart illustrating an embodiment of a process for performing inline security risk analysis for emails using a third-party security analysis service.

FIG. 8 is a functional diagram illustrating a programmed computer system for providing inline mail protection.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Inline mail protection is disclosed. Using the disclosed techniques and systems, email services can be protected using an inline mail protection approach that provides both advanced and improved security risk detection over traditional risk detection solutions while also improving reliability and maximizing compatibility with the underlying email platform. For example, an inline security analysis solution is introduced between the inbound endpoint of an email service and a user's email mailbox. The email service is configured to receive emails without change including allowing the underlying email platform to perform its default and/or initial analysis on inbound emails. Once received by the underlying email platform, and after an optional default inspection on the inbound email, the email service forwards the email to an external and third-party security analysis service. In various embodiments, the forwarding is accomplished by configuring inline transport rules for the email service. Once a forwarded email message is received at the third-party security analysis service, the email is analyzed for security risks using the advanced security analysis implemented by the third-party security analysis service. Importantly, the security risk analysis implemented by the third-party security analysis service can be continuously updated to detect the latest and most advanced email threats with minimal to no changes to the underlying email service platform. The determined security risk results are encoded by the third-party security analysis service into the analyzed email message by modifying the message headers. The analyzed email with modified headers is then routed back to the underlying email platform. Once received at the email platform, modified email mailbox filter rules process the new headers to direct the email into the appropriate email mailbox location, such as a spam, promotions, or quarantine folder. In some embodiments, the email is classified using the modified headers to add different labels to the email. Using the disclosed invention, advanced security risks are detected by the inline security risk engine of the third-party security analysis service while minimizing the impact of the performed additional analysis to the end user. From a user's perspective, the emails arrive in the appropriate mailbox locations without noticeable performance or useability tradeoffs. In some embodiments, an additional second security analysis pass can be performed once an email message is routed to the appropriate folder based on the modified headers. For example, the additional security analysis can be performed on emails within the user's Inbox to identify additional threats including threats that may require additional analysis time or computational resources.

In some embodiments, an implementation of an inline transport rule to forward messages received at an email service provider for a user to a third-party security analysis service different from the email service provider is caused to occur. For example, an inline transport rule is configured at an email service provider, such as a first-party or third-party email service provider, causing all incoming (and/or outgoing) emails to be forwarded to a third-party security analysis service. In some embodiments, the inline transport rules are injected by the third-party security analysis service. For example, the rules can be injected by configuring the third-party security analysis service to support the underlying email service platform. In some embodiments, an implementation of one or more email filtering rules for an email mailbox of the user is caused to occur. For example, filtering rules for an email mailbox are configured, installed, and enabled. The email rules can perform automated actions on email, such as incoming or outgoing email. When the rules are applied, they can automate moving email from a default folder, such as the user's Inbox, to a specified location such as a spam, promotions, quarantine, or hidden folder. In some embodiments, the filtering rules apply labels to the email. For example, in email systems that do not use traditional mailbox folders, the applied labels can be used to designate or classify email.

In some embodiments, the messages are analyzed for security risks and corresponding headers of the messages are modified to include corresponding security analysis results. For example, using the inline transport rule, a message is forwarded to the third-party security analysis service where it is analyzed for security risks. Based on the detected risks, the headers of the message are modified. The modified headers can encode the security analysis results including suggested remediation actions that should be performed. In some embodiments, the analyzed messages with modified headers are routed back to the email service provider, wherein the email service provider uses the one or more email filtering rules to filter the messages based on the corresponding headers of the messages to implement one or more responsive security actions. For example, an analyzed message is routed back to the underlying email service where the new headers trigger automated actions directed by the installed email filtering rules. The automated actions can include responsive security actions based on the security analysis results. For example, messages identified as spam can be automatically moved to a Spam folder. Similarly, messages identified as graymail can be automatically moved to an appropriate mailbox folder such as a promotions, newsletters, product updates, and/or event invites folder. In various embodiments, messages identified as malicious are moved to a quarantine folder and can be hidden from the user.

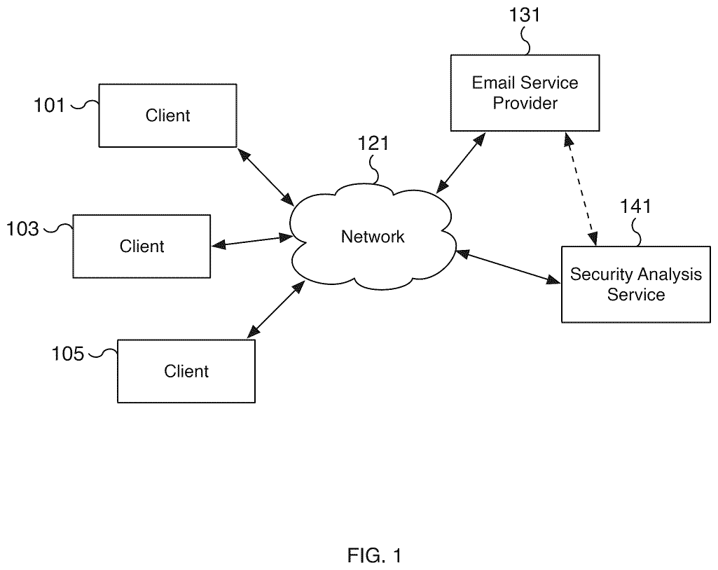

FIG. 1 is a block diagram illustrating an embodiment of a system for providing inline mail protection. Using the disclosed systems and associated techniques, an email message serviced by an email service can be protected from security risks using an inline mail protection solution. In the example shown, email service provider 131 provides email services for clients such as clients 101, 103, and 105. Emails, such as inbound and/or outbound email messages, serviced by email service provider 131, are analyzed for security risks by security analysis service 141 using an inline mail protection solution. Clients 101, 103, and 105 are communicatively connected to email service provider 131 and security analysis service 141 via network 121. Similarly, email service provider 131 and security analysis service 141 are communicatively connected to one another via network 121. Network 121 can be a public or private network. In some embodiments, network 121 is a public network such as the Internet. In various embodiments, email service provider 131 is an email messaging service and clients such as clients 101, 103, and/or 105 can access email service provider 131 for sending and receiving emails. In addition to its core email functionality, email service provider 131 can implement additional features such as a default security analysis implementation. Security analysis service 141 is configured to interoperate with email service provider 131 as an inline solution for mail protection, identifying security risks using its own security analysis implementation. In some embodiments, the security analysis implementation of security analysis service 141 is an advanced AI-driven threat detection process.

In some embodiments, clients 101, 103, and 105 are each a network client device for interfacing with email service provider 131 and/or security analysis service 141. For example, clients 101, 103, and/or 105 can correspond to users of an organization configured to access email services, such as for sending and receiving email messages, via email service provider 131. As another example, clients 101, 103, and/or 105 can correspond to information security personnel or other users with authorized security and/or administrative credentials for configuring, managing, and/or administrating security analysis service 141 with respect to email service provider 131. For example, clients corresponding to an authorized security administrator can configure security analysis service 141 to perform inline security risk detection on all incoming emails received at email service provider 131. The security risk detection and remediation can include analyzing emails to quarantine malicious emails, move graymail emails into a designated Promotions mailbox folder, and move spam emails into a designated Spam folder.

In some embodiments, email service provider 131 is an email service provider platform and can include cloud-based email services for sending and receiving email. With cloud-based email services, users can access their emails on mailboxes hosted by email service provider 131. In some embodiments, users have their email routed through email service provider 131 but their email mailboxes are instead stored on their local devices and can be accessed via a local email client. In various embodiments, email service provider 131 includes an inbound endpoint for receiving incoming emails to recipients. An incoming email may be scanned by a security risk analysis implementation provided by email service provider 131. In various embodiments, the security risk analysis implemented by email service provider 131 can also apply remediation actions for detected risks, such as quarantining a malicious email or moving a junk email to a spam folder, etc. However, a security risk analysis implemented by an underlying email service, such as email service provider 131, often comes with tradeoffs, such as sporadic or irregular security risk detection updates that may exclude the latest or most advanced security risk or limited or restricted customization options including limited remediation options.

In various embodiments, email service provider 131 can be configured to interoperate with an inline mail protection system such as security analysis service 141. For example, inline transport rules can be installed at email service provider 131 to forward incoming emails to security analysis service 141. Additionally, email service provider 131 can be configured with email filtering rules. For example, email filtering rules can be triggered based on email headers to perform responsive security actions. Example actions can include quarantining a malicious email or automatically moving a junk email to a Spam mailbox folder. In various embodiments, inline transport rules and email filtering rules can be configured remotely for email service provider 131 such as via security analysis service 141. By interfacing with security analysis service 141, inbound emails received at email service provider 131 can undergo additional and advanced inline security risk detection provided by security analysis service 141 to detect security risks before an email reaches the user's mailbox destination.

In some embodiments, security analysis service 141 is an inline mail protection solution for detecting security risks in email messages. Unlike traditional approaches, the security risks are detected inline after an inbound email is received at email service provider 131 but before the email is routed to the user's mailbox. Security analysis service 141 intercepts the email via an inline transport rule allowing an email message to be analyzed for security risks before the user can access the email. By performing risk analysis inline, a security analysis result and corresponding responsive security action can be performed before an email is routed to a user's Inbox. For example, after analyzing a message, security analysis service 141 modifies a message's headers to include the corresponding security analysis result. The analyzed message with modified headers is then routed back to the email service, such as email service provider 131, where the headers are used to trigger email filtering rules that implement one or more responsive security actions. For example, the modified headers can be used to designate that an incoming message is a malicious, graymail, spam, or another type of message with a detected security risk. Similarly, the headers can designate appropriate responsive security actions to perform for remediating a detected security risk. In some embodiments, the modified headers are further used to prevent the mail from being re-forwarded back to security analysis service 141 in a loop.

In various embodiments, the security analysis performed by security analysis service 141 can utilize an AI-driven threat detection model and can be continuously and/or frequently retrained and/or updated to detect new risks, threats, and/or encode preferred responsive actions. For example, the AI model(s) used by security analysis service 141 can be updated based on newly detected threats and/or the appropriate responsive action to perform on corresponding threats. In some embodiments, the models are updated based on updates or changes to user preferences, such as the level of a threat that must be detected for an email to be quarantined. In various embodiments, the security risk analysis performed by security analysis service 141 offers an improvement over default, potentially static, and/or infrequently updated implementations offered by an underlying email service provider such as by email service provider 131.

Although single instances of some components have been shown to simplify the diagram of FIG. 1, additional instances of any of the components shown in FIG. 1 may exist. For example, email service provider 131 may be implemented by one or more email service provider servers and security analysis service 141 may be implemented by one or more security analysis service provider servers. In some embodiments, some of the servers and their functionalities may be merged. Additionally, clients 101, 103, and 105 are example client devices. Although three clients are shown (clients 101, 103, and 105), many more additional clients can exist. Similarly, although only a single email service is shown (email service provider 131), many more email services can be supported and/or protected by security analysis service 141. In some embodiments, components not shown in FIG. 1 may also exist and/or the network configuration of the included components may differ from what is shown.

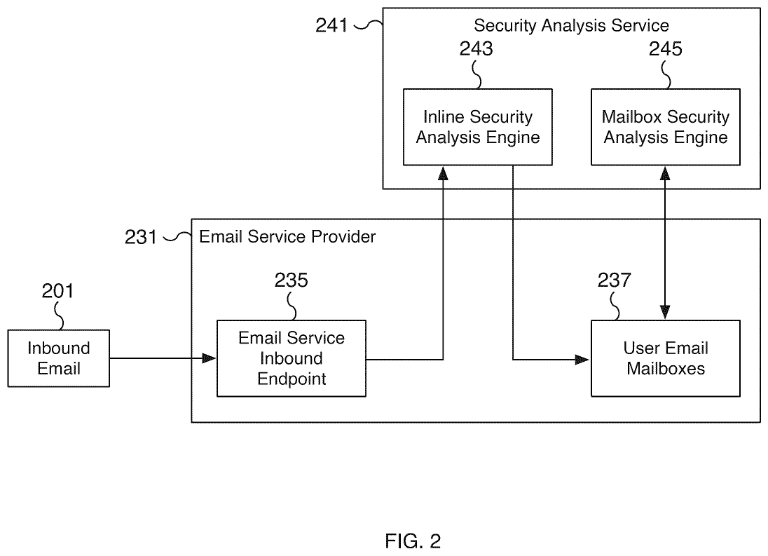

FIG. 2 is a block diagram illustrating an embodiment of a system for providing inline mail protection. In the example shown, email service provider 231 includes components email service inbound endpoint 235 and user email mailboxes 237, and security analysis service 241 includes components inline security analysis engine 243 and mailbox security analysis engine 245. Additional components of email service provider 231 and/or security analysis service 241 may exist but are not shown for the purposes of FIG. 2. As shown in FIG. 2, email service provider 231 receives inbound email 201 at email service inbound endpoint 235 and forwards inbound email 201 to security analysis service 241. At security analysis service 241, the received email message is analyzed by inline security analysis engine 243 and then the analyzed message is routed back to email service provider 231. At email service provider 231, the analyzed email is placed in a proper location of user email mailboxes 237. In various embodiments, mailbox security analysis engine 245 of security analysis service 241 can perform additional security risk analysis on emails from their resting location in user email mailboxes 237. In some embodiments, email service provider 231 is email service provider 131 of FIG. 1 and security analysis service 241 is security analysis service 141 of FIG. 1.

In various embodiments, the diagram of FIG. 2 displays the processing flow for an inbound email message as it undergoes multiple passes of security risk analysis including at least an inline pass performed by inline security analysis engine 243. As shown in FIG. 2, email service provider 231 includes email service inbound endpoint 235 to receive incoming emails such as inbound email 201. Email service provider 231 can be configured with an inline transport rule to forward inbound emails such as inbound email 201 to security analysis service 241. Moreover, email service provider 231 can be further configured with mailbox filtering rules that apply to user email mailboxes 237. For example, based on message headers, different mailbox filtering rules will automatically move a message analyzed by security analysis service 241 from the default Inbox folder to a specified location, such as a quarantine folder, a hidden folder, a Promotions folder, or a Spam folder. In various embodiments, the different folder locations are used to remediate different types of security risks, such as risks posed by malicious, graymail, and junk email messages.

In some embodiments, security analysis service 241 includes components inline security analysis engine 243 and mailbox security analysis engine 245 for performing two different security risk analysis passes. The inline pass is performed by inline security analysis engine 243 and results in modifying the message headers of the analyzed email with the corresponding security analysis results before routing the analyzed message with modified headers back to email service provider 231. A second (and potentially optional) security analysis can be performed on emails at rest, such as emails that are located in user email mailboxes 237, by mailbox security analysis engine 245. For example, using an application programming interface (API) to access user mailboxes of user email mailboxes 237, mailbox security analysis engine 245 can perform a second and additional security risk analysis on received emails. The analysis performed by mailbox security analysis engine 245 can complement the inline security analysis performed by inline security analysis engine 243. For example, the analysis performed by inline security analysis engine 243 may be less resource and/or time intensive allowing for minimal transport delay between receiving inbound email 201 at email service inbound endpoint 235 and when the corresponding analyzed email arrives at user email mailboxes 237. In some embodiments, the analysis performed by mailbox security analysis engine 245 can be more resource intensive including, for example, performing deep and resources-intensive security scans of large email message attachments. In various embodiments, the security risk analysis performed by inline security analysis engine 243 and/or mailbox security analysis engine 245 of security analysis service 241 can be an AI-driven analysis that relies on one or more AI-trained machine learning models.

Although not shown in FIG. 2, in some embodiments, email service provider 231 can implement and perform its own initial security risk analysis pass when inbound email 201 is received at email service inbound endpoint 235 and before inbound email 201 is forwarded to security analysis service 241. In some embodiments, the default security risk implementation of security analysis service 241 can also be performed after the inline security risk analysis is performed by inline security analysis engine 243, such as after an analyzed email is routed back to email service provider 231 by security analysis service 241. In many scenarios, the default security risk analysis implementation performed by email service provider 231 may be more restrictive and more limited than the analysis performed by security analysis service 241. For example, the default security risk analysis implementation of email service provider 231 may a generic security solution with limited capabilities for adapting to detect and remediate new and advanced security threats compared with the security analysis solutions provided by security analysis service 241.

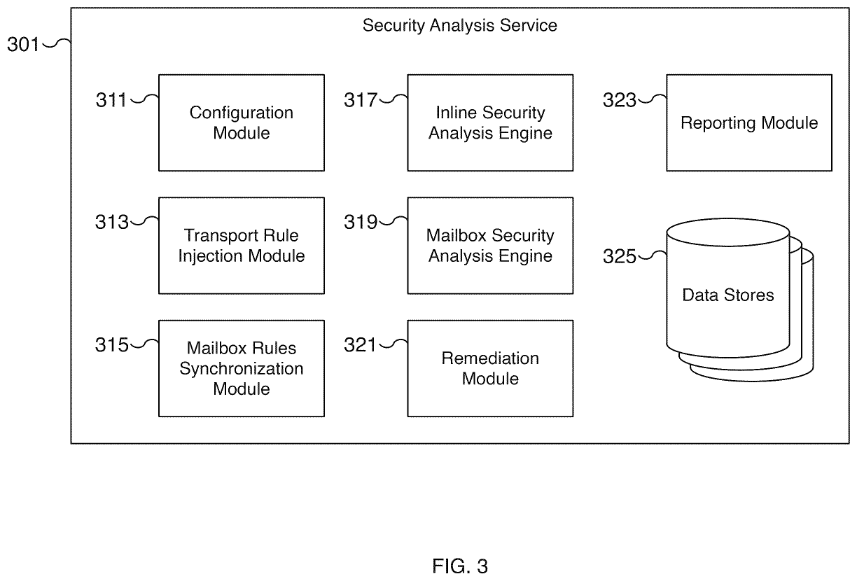

FIG. 3 is a block diagram illustrating an embodiment of a security analysis service for providing inline security analysis for email messages. In the example shown, security analysis service 301 includes configuration module 311, transport rule injection module 313, mailbox rules synchronization module 315, inline security analysis engine 317, mailbox security analysis engine 319, remediation module 321, reporting module 323, and data stores 325. Using security analysis service 301, an email service provider can be configured to use the inline security analysis implementation provided by security analysis service 301 to detect security risks. For example, emails received at an email service are forwarded to security analysis service 301 via an injected inline transport rule. Once received at security analysis service 301, the email message is analyzed for security risks and the message headers are modified to include the corresponding security analysis results. The analyzed message with modified headers is then routed back to the email service provider where synchronized mailbox rules are used to implement one or more responsive security actions based on the detected security risk. In some embodiments, security analysis service 301 is security analysis service 141 of FIG. 1 and/or security analysis service 241 of FIG. 2. In some embodiments, the email service provider is email service provider 131 of FIG. 1 and/or email service provider 231 of FIG. 2.

In some embodiments, configuration module 311 is a processing module for configuring a security analysis service for performing inline analysis of emails received at an email provider. For example, configuration module 311 can be used to set up authentication and security permissions for configuring an email service provider including for setting up access permissions and settings for setting transport rules and synchronizing mailbox filtering rules at the corresponding email service provider. In some embodiments, configuration module 311 is further used for configuring security risk detection and remediation settings, such as for configuring different types of remediation actions depending on types of detected security risks. In some embodiments, in addition to configuring inline security analysis, configuration module 311 may also be used for configuring mailbox-based security analysis. In various embodiments, users can interface with configuration module 311 via a web interface such as a web application or web service.

In some embodiments, transport rule injection module 313 is a processing module for configuring one or more inline transport rules at an email service provider. Once installed at the email service provider, an inline transport rule will forward inbound emails to security analysis service 301 for security risk analysis. For example, one or more inline transport rules are injected at the email service provider that directs newly received inbound emails to security analysis service 301. In some embodiments, the installed injection rules prevent a forwarding loop such that email already analyzed by security analysis service 301 is not re-forwarded a second time to security analysis service 301.

In some embodiments, mailbox rules synchronization module 315 is a processing module for updating and synchronizing mailbox filtering rules at an email service provider. For example, mailbox rules synchronization module 315 can install and update the appropriate mailbox filtering rules to implement desired responsive security actions for analyzed emails. The installed rules can be triggered based on message headers that are modified by security analysis service 301 during inline security risk analysis performed by inline security analysis engine 317. In some embodiments, mailbox rules synchronization module 315 further monitors changes to the mailbox rules and performs self-healing functions. For example, in the event mailbox rules are wrongly modified (including whether they are modified inadvertently or maliciously), mailbox rules synchronization module 315 will correct the mailbox rules to ensure that the rules continue to function properly and that the appropriate responsive security actions are performed for analyzed emails. In various embodiments, the mailbox filtering rules can automatically modify analyzed emails such as moving a malicious email to a quarantine folder or a graymail email to a Promotions folder. Other actions a rule can perform can include modifying the email itself, such as removing an attachment or modifying potentially malicious links embedded in an email, modifying the recipient list of an email, and injecting warnings into the email, etc. In various embodiments, the mailbox filtering rules prevent emails with security risks from reaching a user's Inbox.

In some embodiments, inline security analysis engine 317 is a processing module for performing inline security analysis on an email message. Inline security analysis engine 317 can analyze an email for security risks and modify the message headers to include corresponding security analysis results. For example, the message headers can be modified to include header information describing an identified security risk, determined risk assessment scores, and/or remediation actions. After a message has been analyzed, the analyzed message with modified headers is routed back to the email service provider where the message headers are used by the mailbox filtering rules to implement responsive security actions. In various embodiments, the included message header information is used by the mailbox filtering rules that are installed at the email service provider and managed by mailbox rules synchronization module 315.

In some embodiments, mailbox security analysis engine 319 is a processing module for analyzing emails that reside at rest in a user mailbox. Unlike inline security analysis engine 317, mailbox security analysis engine 319 accesses the emails from the email service provider, such as via an application programming interface (API). The emails can be analyzed and any detected security risks remediated. In some embodiments, the analysis performed by mailbox security analysis engine 319 may be more resource intensive. For example, the security risk analysis performed by mailbox security analysis engine 319 can include deep and resources-intensive security scans of large email message attachments, and/or employ a more extensive set of known security risks.

In various embodiments, the security risk analyses performed by inline security analysis engine 317 and/or mailbox security analysis engine 319 are AI-driven processed and may utilize one or more trained machine learning models including large language models. The models used for security risk analysis can be continuously and/or frequently retrained and/or updated to detect new risks, threats, and/or encode preferred responsive actions. For example, the AI model(s) used by inline security analysis engine 317 and/or mailbox security analysis engine 319 can be updated based on newly detected threats and/or the appropriate responsive action to perform on corresponding threats. In some embodiments, the models are updated based on updates or changes to user preferences, such as the level of a threat that must be detected for an email to be quarantined. In various embodiments, the security risk analyses performed by inline security analysis engine 317 and/or mailbox security analysis engine 319 offer an improvement over default, potentially static, and/or infrequently updated implementations offered by an underlying email service provider.

In some embodiments, remediation module 321 is a processing module for resolving identified security risks, such as a malicious inbound email. For example, for messages analyzed inline by inline security analysis engine 317, remediation module 321 can determine the appropriate headers and/or header information to include in a message to address a detected security risk when routed back to the email service provider. In some embodiments, the remediation actions are performed via an API. For example, an API or similar interface can be used for accessing an email service provider to implement remediation actions, such as for messages analyzed by mailbox security analysis engine 319. In some embodiments, remediation module 321 utilizes an AI-driven approach such as a machine learning approach to determine the appropriate remediation action and corresponding responsive security actions. The utilized models can be updated based on learned data including analyzed messages and user responses to remediation actions, among other feedback.

In some embodiments, reporting module 323 is a processing module for providing reporting data on security analysis results provided by security analysis service 301. In various embodiments, the provided reporting data can include different reports such as security analysis reports and remediation results. The provided reports can be used to assess and improve overall email security as well as user security awareness. In some embodiments, reporting module 323 provides interactive and/or more granular details including real-time reporting on detected security risks. For example, reporting module 323 can display security analysis results for different users based on analyzed incoming email messages. In some embodiments, the results include aggregated results such as results aggregated by user groups, user location, user domain, detected security risk, risk severity, etc.

In some embodiments, data stores 325 are one or more data stores used for providing security risk analysis including inline security risk analysis. For example, data stores 325 can be used to store data associated with security risks including models for detecting and remediating risks. Other stored data can include security risk analysis data including risk analysis logs and tracked security risks and remediation actions. In some embodiments, data stores 325 are used for storing and retrieving security risk analysis results and can include reporting data for providing results to users and/or security risk administrators. In the example shown, data stores 325 can be utilized by the different modules of security analysis service 301. Although shown as integrated with security analysis service 301, data stores 325 can include distributed and/or third-party data storage services.

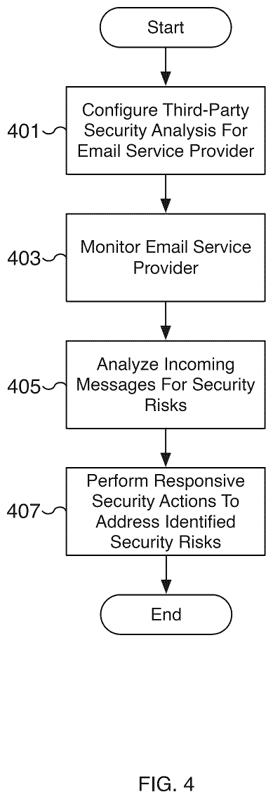

FIG. 4 is a flow chart illustrating an embodiment of a process for protecting emails against security threats using a third-party security analysis service. For example, using the process of FIG. 4, a third-party security analysis service can be configured to monitor and analyze emails for an email service provider. The security analysis can be performed inline on inbound emails and/or on emails at rest. In some embodiments, the security analysis performed by the third-party security analysis service is AI-driven and is adaptive to new email threats and preferred remediation actions. In some embodiments, the third-party security analysis service is security analysis service 141 of FIG. 1, security analysis service 241 of FIG. 2, and/or security analysis service 301 of FIG. 3. In some embodiments, the underlying email service provider is email service provider 131 of FIG. 1 and/or email service provider 231 of FIG. 2.

At 401, third-party security analysis for an email service provider is configured. For example, using a configurating interface, a third-party security analysis service is configured to monitor and analyze emails for an email service provider. In some embodiments, in addition to configuring access and interoperability permissions and settings, the email service provider is configured with one or more inline transport rules and mailbox filtering rules. The inline transport rules are used to forward inbound emails received at the email service provider to the third-party security analysis service, and the mailbox filtering rules are used to process the analyzed emails with modified message headers. For emails analyzed at rest, such as emails already routed to a mailbox folder, the third-party security analysis service can access the emails for analysis using an interoperability interface such as an application programming interface (API).

At 403, the email service provider is monitored. For example, the email service provider is monitored for inbound emails and/or changes that impact third-party security analysis such as changes to the inline transport rules and/or mailbox filtering rules. When an inbound email is received at the email service provider, an inline transport rule forwards the email to the third-party security analysis service. When changes to the email service provider are detected, the third-party security analysis service can reconfigure the email service provider settings to restore the proper transport and mailbox filtering rules. In some embodiments, the rules may be modified and/or updated to adapt to new configuration changes or security risks.

At 405, incoming messages are analyzed for security risks. For example, incoming email messages are accessed by the third-party security analysis service to identify security risks and to determine the appropriate remediation action for an identified risk. The analysis for security risks can be performed inline, such as by forwarding inbound emails to the third-party security analysis service and then re-routing the analyzed email back to the email service provider where responsive security actions are performed. In some embodiments, the analysis is performed for email messages at rest by accessing the emails after they are routed to a destination mailbox folder, such as a user's Inbox. In some embodiments, the security risk analysis is performed both inline and as well as at-rest allowing for multiple passes and more refined security risk detection. Similarly, in some embodiments, the email service provider may additionally perform its own security risk analysis allowing for another layer of protection.

At 407, responsive security actions are performed to address identified security risks. For example, one or more responsive security actions, such as quarantining an email, disabling a recipient user account, or blocking a sender account, are performed to remediate an identified security risk. In the case of inline security risk detection, the corresponding security analysis results are embedded in the analyzed email's message headers, and mailbox filtering rules are implemented to remediate the risk posed by the email. For example, a malicious email can be automatically moved to a hidden folder before the email can reach a user's Inbox. Similarly, a graymail email can be automatically moved to a Promotions folder before the email can reach a user's Inbox. Other responsive security actions, such as removing attachments, modifying embedded links, etc. can also be performed based on the type of risk identified. In some embodiments, the responsive security actions include moving an email to a quarantine or hidden folder, a designated graymail mailbox folder, a designated spam mailbox folder, or another specific mailbox folder. In some embodiments, the responsive security actions include modifying a body text of an email, modifying an attachment of an email, modifying an embedded link of an email, modifying a recipient of an email, or creating a filter to block a sender of an email. For example, the body text of an email can be modified to include a warning message for the identified security risk.

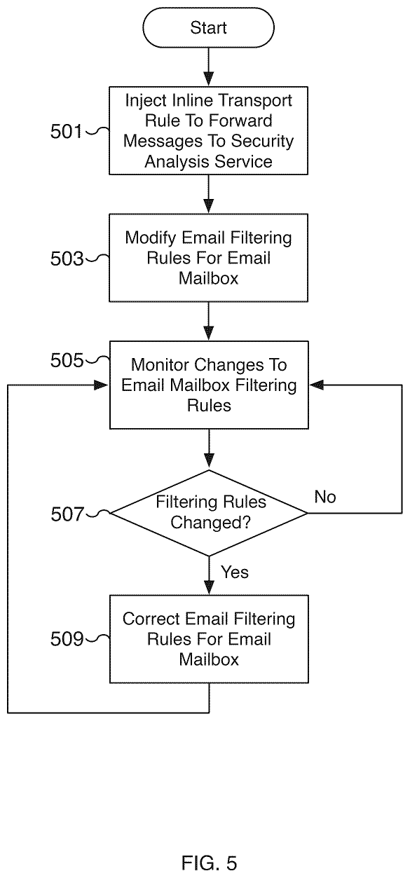

FIG. 5 is a flow chart illustrating an embodiment of a process for configuring inline security risk analysis for emails using a third-party security analysis service. For example, using the process of FIG. 5, a third-party security analysis service can be configured to monitor and analyze emails for an email service provider. As part of the configuration, the third-party security analysis service modifies settings at the email service provider to ensure interoperability with the security analysis results. In some embodiments, the process of FIG. 5 is performed by a third-party security analysis service at 401 and/or 403 of FIG. 4. In some embodiments, the third-party security analysis service is security analysis service 141 of FIG. 1, security analysis service 241 of FIG. 2, and/or security analysis service 301 of FIG. 3. In some embodiments, the underlying email service provider is email service provider 131 of FIG. 1 and/or email service provider 231 of FIG. 2.

At 501, an inline transport rule to forward messages to the security analysis service is injected at the email service provider. For example, the third-party security analysis service updates inline transport rules configured for the email service provider to include a rule to forward inbound emails to the third-party security analysis service. In some embodiments, the new inline transport rule is injected at the email service provider using a remote configuration interface. In some embodiments, multiple inline transport rules are injected including a rule to forward newly received inbound emails to the third-party security analysis service and a second rule to prevent previously analyzed emails that have been routed back to the email service provider from being re-forwarded to the third-party security analysis service. For example, additional inline transport rules can be configured to prevent forwarding loops.

At 503, email filtering rules for an email mailbox are modified. For example, the third-party security analysis service updates email mailbox filter rules for the email service provider. The modified mailbox filtering rules can interpret message headers of analyzed emails and apply the appropriate responsive security actions, such as quarantining a malicious email. In some embodiments, each user may have their own configured email filtering rules and the rules are modified on a per-user basis. In various embodiments, the email mailbox rules configured at the email service provider can be modified by the security analysis service using a remote configuration interface.

At 505, changes to email mailbox filtering rules are monitored. For example, the security analysis service monitors the configured email mailbox filtering rules for changes including both inadvertent and intentional changes. Changes to the mailbox filter rules can disable remediation actions, and identifying changes made to the rule set allows the security analysis service to perform self-healing actions to ensure responsive security actions continue to be performed reliably and consistently at the email service provider. In some embodiments, the identified changes are logged and trigger notification and/or warning messages. For example, changes can trigger an email to security administrators and/or users whose mailbox rules have been modified. The notifications can be used to initiate additional security training and/or to update permissions including account modification permissions.

At 507, a determination is made whether the filtering rules have changed. In the event the filtering rules have changed, processing proceeds to step 509. In the event the filtering rules have not changed, processing loops back to step 505.

At 509, email filtering rules for an email mailbox are corrected. For example, the mailbox filtering rules are corrected to address the identified changes and to restore potentially disabled security actions. In some embodiments, the changes are further logged and can trigger an audit of recently received emails to ensure that no security risks were missed during the period when the filtering rules were incorrectly configured. In various embodiments, the security analysis service maintains the authoritative version of the mailbox filtering rules for each user and the email filtering rules are synchronized from the security analysis service to the email service provider. For example, an email filtering rule set stored at the security analysis service can be used as a source for synchronizing the email filtering rules for a user's email mailbox.

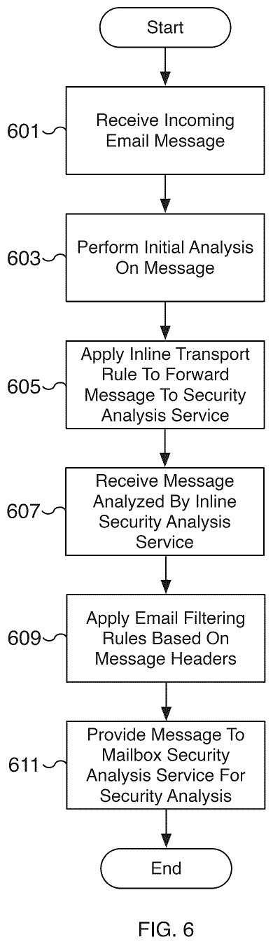

FIG. 6 is a flow chart illustrating an embodiment of a process for performing inline security risk analysis for emails using a third-party security analysis service. For example, using the process of FIG. 6, an email service provider can utilize a third-party security analysis service for performing inline security risk analysis and an optional mailbox-based risk security analysis. Moreover, the process of FIG. 6 further allows the email service provider to perform its own security risk analysis ahead of (and/or after) the security analysis performed by the third-party security analysis service, allowing for an additional layer of protection. In some embodiments, the process of FIG. 6 is performed by an email service provider at 403, 405, and/or 407 of FIG. 4. In some embodiments, the email service provider is email service provider 131 of FIG. 1 and/or email service provider 231 of FIG. 2. In some embodiments, the third-party security analysis service is security analysis service 141 of FIG. 1, security analysis service 241 of FIG. 2, and/or security analysis service 301 of FIG. 3.

At 601, an incoming email message is received. For example, an email service provider receives an inbound email at an inbound endpoint of the email service provider. The received inbound email includes a sender and one or more recipients whose users have accounts at the email service provider.

At 603, an initial analysis is performed on the message. For example, the email service provider performs an initial security risk analysis on the inbound email message. The security risk analysis can be a default and/or generic implementation provided by the email service provider. In some embodiments, the implementation provided by the email service provider cannot be configured and therefore may be limited in functionality. For example, the email service provider implementation may do a coarse analysis to filter out easy to detect malicious emails but may not detect more sophisticated or newer security risks.

At 605, an inline transport rule is applied to forward the message to a security analysis service. For example, an inline transport rule injected by the third-party security analysis service forwards the inbound email message to the third-party security analysis service for inline security risk analysis. In some embodiments, the inline transport rule first determines that the email has not already been analyzed by the third-party security analysis service. For example, to prevent forwarding loops, an inbound email is only forwarded to the third-party security analysis service a single time.

At 607, the message analyzed by the inline security analysis service is received. For example, the analyzed version of the email forwarded at 605 for inline security risk analysis by the third-party security analysis service is received. The analyzed email includes modified headers that encode the security analysis results determined by the third-party security analysis service. For example, different headers or header values can indicate different detected security risks and/or different remediation approaches and/or security actions to perform in response to a detected security risk.

At 609, email filtering rules based on message headers are applied. For example, the installed email filtering rules analyze the modified headers of the message received at 607. Based on the headers and their encoded data results, the filtering rules can apply responsive security actions to address detected security risks. For example, an email with headers indicating the email is malicious can be automatically moved to a quarantine and/or hidden folder. Similarly, an email with headers indicating the email is graymail can be automatically moved to a Promotions folder, and an email with headers indicating the email is spam or junk can be automatically moved to a Spam folder. In various embodiments, the email filtering rules can prevent emails with security risks from landing in a user's Inbox where it can be inadvertently opened and read. In some embodiments, the email filtering rules can perform additional security actions such as modifying the email to remove/modify attachments, modify embedded links, and/or change/add user recipients, among other responsive security actions.

At 611, the message is provided to a mailbox security analysis service for security risk analysis. For example, after initial analysis is performed at 603 and the inline analysis is performed by forwarding the inbound email at 605, an additional security risk analysis pass can be performed at 611 on an email in an at rest condition in a user's email mailbox. In some embodiments, an email in a user's mailbox, such as in the user's Inbox folder, is provided to a third-party mailbox security analysis service for additional risk analysis. As another example, a message quarantined and moved to a quarantine folder by the default security risk analysis performed by the email service provider at 603 can be analyzed by the mailbox security analysis service to determine the quarantined message is a false positive. The additional analysis performed may be optional and/or may be performed only on selected emails. In some embodiments, the third-party mailbox security analysis service is implemented by the same security analysis service that performs the inline analysis. The additional analysis may be a more resource intensive analysis and may require additional processing power and/or time compared to the inline analysis performed between steps 605 and 607. In various embodiments, the mailbox security analysis service accesses the mailbox emails via an interoperability interface such as an application programming interface (API) provided by the email service provider.

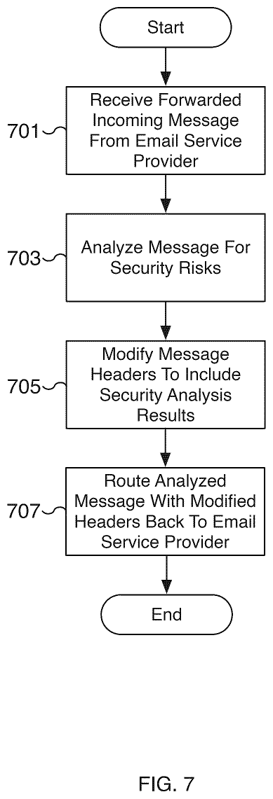

FIG. 7 is a flow chart illustrating an embodiment of a process for performing inline security risk analysis for emails using a third-party security analysis service. For example, using the process of FIG. 7, a third-party security analysis service can perform an inline analysis of emails for an underlying email service provider. As part of the analysis, the message headers are modified to encode corresponding security analysis results before the analyzed message with modified headers is rerouted back to the underlying email service provider. Once at the underlying email service provider, the modified message headers are used to trigger and perform responsive security actions. In some embodiments, the process of FIG. 7 is performed by a third-party security analysis service at 403 and/or 405 of FIG. 4. In some embodiments, the third-party security analysis service is security analysis service 141 of FIG. 1, security analysis service 241 of FIG. 2, and/or security analysis service 301 of FIG. 3. In some embodiments, the underlying email service provider is email service provider 131 of FIG. 1 and/or email service provider 231 of FIG. 2.

At 701, a forwarded incoming message is received from an email service provider. For example, an underlying email service provider forwards an incoming email to the third-party security analysis service to perform inline security risk analysis on the inbound email. The email received at 701 is an email in transit that has not reached the recipient user's mailbox such as the target recipient's email Inbox.

At 703, the message is analyzed for security risks. For example, the email received at 701 is analyzed for security risks such as to determine whether the email is malicious, graymail, junk or spam, or another type of email classification. In some embodiments, more granular security risk results are determined such as a specific attack type used by a malicious email and/or the corresponding attack campaign associated with a malicious email. In various embodiments, the analysis performed can be an AI-driven analysis that utilizes trained machine learning models to accurately identify security risks and/or to determine the appropriate remediation actions.

At 705, message headers are modified to include security analysis results. For example, the email message headers of the email are modified to encode the determined security analysis results. The encoded results can include a risk description, risk scores, and/or remediation actions/plans. In some embodiments, the message header modifications also indicate that an inline analysis was performed on the message by the security analysis service. In various embodiments, the modified email headers correspond to email filtering rules that are configured at the underlying email service provider for performing responsive security actions based on the modified email headers.

At 707, the analyzed message with modified headers is routed back to the email service provider. For example, once the message is analyzed and the results encoded into the analyzed email's message headers, the analyzed message with modified headers is routed back to the underlying email service provider. In various embodiments, the processing time introduced by forwarding an inbound email to the third-party security analysis service, performing the security risk analysis and header updates in the previous steps, and routing the analyzed email back to the underlying email service provider is minimal. In various embodiments, the underlying email service provider is configured to receive the analyzed message and will apply mailbox filtering rules to determine how the analyzed email should be processed including how to appropriately address and/or remediate an identified security risk.

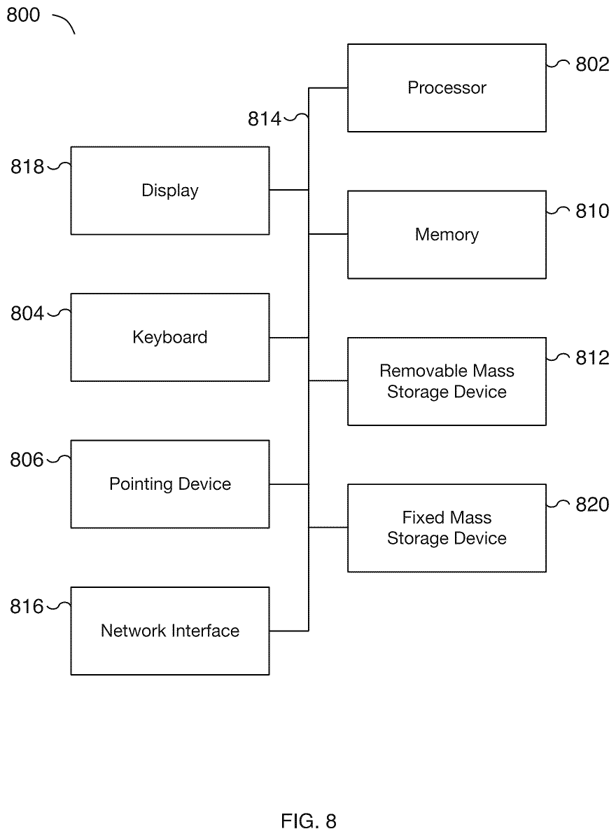

FIG. 8 is a functional diagram illustrating a programmed computer system for providing inline mail protection. As will be apparent, other computer system architectures and configurations can be utilized for providing inline mail protection. Examples of computer system 800 include clients 101, 103, and 105 of FIG. 1, one or more computers of email service provider 131 of FIG. 1 and/or security analysis service 141 of FIG. 1, one or more computers of email service provider 231 of FIG. 2 and/or security analysis service 241 of FIG. 2, and/or one or more computers of security analysis service 301 of FIG. 3. Computer system 800, which includes various subsystems as described below, includes at least one microprocessor subsystem (also referred to as a processor or a central processing unit (CPU)) 802. For example, processor 802 can be implemented by a single-chip processor or by multiple processors. In some embodiments, processor 802 is a general purpose digital processor that controls the operation of the computer system 800. Using instructions retrieved from memory 810, the processor 802 controls the reception and manipulation of input data, and the output and display of data on output devices (e.g., display 818). In various embodiments, one or more instances of computer system 800 can be used to implement at least portions of the processes of FIGS. 4-7.

Processor 802 is coupled bi-directionally with memory 810, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 802. Also as is well known in the art, primary storage typically includes basic operating instructions, program code, data and objects used by the processor 802 to perform its functions (e.g., programmed instructions). For example, memory 810 can include any suitable computer-readable storage media, described below, depending on whether, for example, data access needs to be bi-directional or unidirectional. For example, processor 802 can also directly and very rapidly retrieve and store frequently needed data in a cache memory (not shown).

A removable mass storage device 812 provides additional data storage capacity for the computer system 800, and is coupled either bi-directionally (read/write) or unidirectionally (read only) to processor 802. For example, storage 812 can also include computer-readable media such as magnetic tape, flash memory, PC-CARDS, portable mass storage devices, holographic storage devices, and other storage devices. A fixed mass storage 820 can also, for example, provide additional data storage capacity. The most common example of mass storage 820 is a hard disk drive. Mass storages 812, 820 generally store additional programming instructions, data, and the like that typically are not in active use by the processor 802. It will be appreciated that the information retained within mass storages 812 and 820 can be incorporated, if needed, in standard fashion as part of memory 810 (e.g., RAM) as virtual memory.

In addition to providing processor 802 access to storage subsystems, bus 814 can also be used to provide access to other subsystems and devices. As shown, these can include a display monitor 818, a network interface 816, a keyboard 804, and a pointing device 806, as well as an auxiliary input/output device interface, a sound card, speakers, and other subsystems as needed. For example, the pointing device 806 can be a mouse, stylus, track ball, or tablet, and is useful for interacting with a graphical user interface.

The network interface 816 allows processor 802 to be coupled to another computer, computer network, or telecommunications network using a network connection as shown. For example, through the network interface 816, the processor 802 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect the computer system 800 to an external network and transfer data according to standard protocols. For example, various process embodiments disclosed herein can be executed on processor 802, or can be performed across a network such as the Internet, intranet networks, or local area networks, in conjunction with a remote processor that shares a portion of the processing. Additional mass storage devices (not shown) can also be connected to processor 802 through network interface 816.

An auxiliary I/O device interface (not shown) can be used in conjunction with computer system 800. The auxiliary I/O device interface can include general and customized interfaces that allow the processor 802 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 8 is but an example of a computer system suitable for use with the various embodiments disclosed herein. Other computer systems suitable for such use can include additional or fewer subsystems. In addition, bus 814 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
causing an implementation of an inline transport rule to forward messages received at an email service provider for a user to a third-party security analysis service different from the email service provider;
causing an implementation of one or more email filtering rules for an email mailbox of the user;
analyzing the messages for security risks and modifying corresponding headers of the messages to include corresponding security analysis results; and
routing the analyzed messages with modified headers back to the email service provider, wherein the email service provider uses the one or more email filtering rules to filter the messages based on the corresponding headers of the messages to implement one or more responsive security actions.

2. The method of claim 1, wherein at least one of the headers of the modified corresponding headers of the messages corresponds to an identification of a malicious email, a promotion email, or a spam email.

3. The method of claim 1, wherein the one or more responsive security actions include automatically moving an email to a quarantine or hidden folder.

4. The method of claim 1, wherein the one or more responsive security actions include automatically moving an email to a designated graymail mailbox folder.

5. The method of claim 1, wherein the one or more responsive security actions include automatically moving an email to a designated spam mailbox folder.

6. The method of claim 1, wherein the one or more responsive security actions include modifying a body text of an email, modifying an attachment of an email, modifying an embedded link of an email, modifying a recipient of an email, or creating a filter to block a sender of an email.

7. The method of claim 1, further comprising:
identifying a change in the one or more email filtering rules for the email mailbox of the user; and
correcting the change in the one or more email filtering rules for the email mailbox of the user.

8. The method of claim 1, wherein the one or more email filtering rules for the email mailbox of the user are synchronized with a filtering rule set stored by the third-party security analysis service.

9. The method of claim 1, further comprising:
accessing via the third-party security analysis service one or more emails from the email mailbox of the user; and
analyzing the accessed one or more emails from the email mailbox of the user for security risks.

10. The method of claim 1, further comprising causing an implementation of a second inline transport rule to prevent forwarding loops for the messages received at the email service provider for the user and previously analyzed by the third-party security analysis service.

11. A system, comprising:
one or more processors configured to:
cause an implementation of an inline transport rule to forward messages received at an email service provider for a user to a third-party security analysis service different from the email service provider;
cause an implementation of one or more email filtering rules for an email mailbox of the user;
analyze the messages for security risks and modify corresponding headers of the messages to include corresponding security analysis results; and
route the analyzed messages with modified headers back to the email service provider, wherein the email service provider uses the one or more email filtering rules to filter the messages based on the corresponding headers of the messages to implement one or more responsive security actions; and
a memory coupled to the one or more processors, wherein the memory is configured to provide the one or more processors with instructions.

12. The system of claim 11, wherein at least one of the headers of the modified corresponding headers of the messages corresponds to an identification of a malicious email, a promotion email, or a spam email.

13. The system of claim 11, wherein the one or more responsive security actions include automatically moving an email to a quarantine or hidden folder.

14. The system of claim 11, wherein the one or more responsive security actions include automatically moving an email to a designated graymail mailbox folder.

15. The system of claim 11, wherein the one or more responsive security actions include automatically moving an email to a designated spam mailbox folder.

16. The system of claim 11, wherein the one or more responsive security actions include modifying a body text of an email, modifying an attachment of an email, modifying an embedded link of an email, modifying a recipient of an email, or creating a filter to block a sender of an email.

17. The system of claim 11, wherein the one or more processors are further configured to:
identify a change in the one or more email filtering rules for the email mailbox of the user; and
correct the change in the one or more email filtering rules for the email mailbox of the user.

18. The system of claim 11, wherein the one or more email filtering rules for the email mailbox of the user are synchronized with a filtering rule set stored by the third-party security analysis service.

19. The system of claim 11, wherein the one or more processors are further configured to:
access via the third-party security analysis service one or more emails from the email mailbox of the user; and
analyze the accessed one or more emails from the email mailbox of the user for security risks.

20. A computer program product, the computer program product being embodied in a non-transitory computer readable storage medium and comprising computer instructions for:
causing an implementation of an inline transport rule to forward messages received at an email service provider for a user to a third-party security analysis service different from the email service provider;
causing an implementation of one or more email filtering rules for an email mailbox of the user;
analyzing the messages for security risks and modifying corresponding headers of the messages to include corresponding security analysis results; and
routing the analyzed messages with modified headers back to the email service provider, wherein the email service provider uses the one or more email filtering rules to filter the messages based on the corresponding headers of the messages to implement one or more responsive security actions.
